(19) United States
(12) Patent Application Publication
(10) Pub. No.: US 2026/0155045 A1
(43) Pub. Date: Jun. 4, 2026

(54) METHOD, ELECTRONIC DEVICE, AND STORAGE MEDIUM FOR DETERMINING TRAFFIC RISK VALUE

(71) Applicants: CHINA MOBILE IOT COMPANY LIMITED, CHONGQING (CN); CHINA MOBILE COMMUNICATIONS GROUP CO., LTD., BEIJING (CN)

(72) Inventors: Shangyun YANG, CHONGQING (CN); Chuanyu LV; Chunyang LIU, CHONGQING (CN); Jun HE, CHONGQING (CN); Shaojie XUE, CHONGQING (CN)

(21) Appl. No.: 19/462,869

(22) Filed: Jan. 28, 2026

Related U.S. Application Data
(63) Continuation of application No. PCT/CN2024/134308, filed on Nov. 25, 2024.

(30) Foreign Application Priority Data
Nov. 29, 2023 (CN) 202311619333.8

(51) Int. Cl. G08G 1/16; G08G 1/01; G08G 1/052; G08G 1/0967

(52) U.S. Cl. CPC G08G 1/166; G08G 1/0129; G08G 1/0133; G08G 1/0141; G08G 1/052; G08G 1/0967

(57) ABSTRACT

The present application discloses a method, an electronic device, and a storage medium for determining traffic risk value. In the method, by means of real-time vehicle information of vehicles within the traffic-accident prone area, first real-time risk values of other vehicles to a target vehicle can be determined; by means of the real-time vehicle information and real-time environmental information, a second real-time risk value of a traffic-accident prone area can be determined; when the first real-time risk values or the second real-time risk value increase, a target real-time risk value increases accordingly.

### CROSS-REFERENCE TO RELATED APPLICATION

The present application is a continuation of International (PCT) Patent Application No. PCT/CN2024/134308, filed on Nov. 25, 2024, claims priority to Chinese Patent Application No. 202311619333.8, filed on Nov. 29, 2023, the entire contents of which are incorporated herein by reference.

### TECHNICAL FIELD

The present disclosure relates to the technical field of vehicle safe driving, and in particular to a method, an electronic device, and a non-transitory storage medium for determining a traffic risk value.

### BACKGROUND

During driving process of a vehicle, accidents may occur due to various reasons.

In the related art, to reduce the occurrence of accidents, the driving behavior of drivers may be analyzed, such as behaviors like driver fatigue driving or speeding, or a risk analysis of driving behaviors of adjacent vehicles may be performed. The analyzed data may be unidimensional, and a result of the risk analysis may not be accurate enough. For example, when a vehicle drives to a certain road section, the related art cannot determine whether there is a safety risk on the certain road section. Thus, safety of a user cannot be effectively guaranteed.

Therefore, the problem existing in the related art is that, accuracy of the risk analysis is poor. Thus, the safety of the user cannot be effectively guaranteed.

### SUMMARY

Some embodiments of the present disclosure may provide a method, an electronic device, and a non-transitory storage medium for determining a traffic risk value.

In a first aspect, some embodiments of the present disclosure may provide a method for determining a traffic risk value, including the blocks as follows.

Acquiring real-time information of a preset traffic-accident prone area. The real-time information includes real-time environmental information and real-time vehicle information of vehicles within the traffic-accident prone area.

Determining first real-time risk values of a target vehicle as perceived by other vehicles, based on the real-time vehicle information. Determining a second real-time risk value of the traffic-accident prone area, based on the real-time information.

Determining a target real-time risk value, based on the first real-time risk values and the second real-time risk value. The target real-time risk value is positively correlated with the first real-time risk values and the second real-time risk value.

In a second aspect, some embodiments of the present disclosure may further provide an electronic device. The electronic device may include a processor and a memory storing computer program instructions. In a case where the computer program instructions are executed, the processor may execute the method for determining a traffic risk value based on the first aspect or any possible execution of the first aspect.

In a third aspect, some embodiments of the present disclosure may further provide a non-transitory computer storage medium. Computer-readable program instructions are stored on the non-transitory computer storage medium. In a case where the computer-readable program instructions are executed by a processor are configured to execute the method for determining a traffic risk value based on the first aspect or any possible execution of the first aspect.

### BRIEF DESCRIPTION OF THE DRAWINGS

To describe the technical solutions in some embodiments of the present disclosure more clearly, the following briefly introduces the accompanying drawings required for describing some embodiments. For those skilled in the art, other drawings can also be obtained from these accompanying drawings without creative effort.

FIG. 1 is a schematic flowchart of a method for determining a traffic risk value based on some embodiments of the present disclosure.

FIG. 2 is another schematic flowchart of the method for determining a traffic risk value based on some embodiments of the present disclosure.

FIG. 3 is a schematic structural diagram of a system for determining a traffic risk value based on some embodiments of the present disclosure.

FIG. 4 is a schematic diagram of a traffic-accident prone area based on some embodiments of the present disclosure.

FIG. 5 is a schematic diagram of an apparatus for determining a traffic risk value based on some embodiments of the present disclosure.

FIG. 6 is a schematic structural diagram of an electronic device based on some embodiments of the present disclosure.

### DETAILED DESCRIPTION

The features and exemplary embodiments of various aspects of the present disclosure will be described in detail below. To make the objectives, technical solutions, and advantages of the present disclosure clearer, the present disclosure is further described in detail below with reference to the accompanying drawings and specific embodiments. It should be understood that the specific embodiments described herein are only used to explain the present disclosure and not to limit the present disclosure. For those skilled in the art, the present disclosure can be executed without some of the details. The following description of some embodiments is merely to provide a better understanding of the present disclosure by illustrating examples of the present disclosure.

It should be noted that, in this document, relational terms such as “first” and “second” are only used to distinguish one entity or operation from another entity or operation, and do not necessarily require or imply that there is any such actual relationship or order between these entities or operations. Moreover, the terms “include”, “contain” or any other variations thereof are intended to cover non-exclusive inclusion, so that a process, a method, an article or a device including a series of elements not only may include those elements, but also may include other elements not explicitly listed, or also may include elements inherent to such process, method, article or device. Without further restrictions, an element defined by the phrase “including a . . . ” does not exclude the existence of other identical elements in the process, the method, the article or the device that may include the element.

As described in the background, during the driving process of a vehicle, accidents may occur due to various reasons.

In the related art, to reduce the occurrence of the accidents, a risk analysis of driving behaviors may be performed, such as driving behaviors like fatigue driving or over-speeding of drivers, or a risk analysis of driving behaviors of adjacent vehicles may be performed. Data of the above risk analysis may be overly singular, and a result of the above risk analysis may be not accurate enough. For example, when a vehicle drives to a certain road section, the related art may fail to determine whether the certain road section has a safety risk, and fail to estimate in advance whether there is a safety risk when a vehicle drives to the certain road section, and fail to effectively guarantee safety of a user.

In accident-prone areas, the accidents may be due to “unavoidable” blind spots of large heavy-duty freight vehicles. The closer to the large heavy-duty freight vehicles, the more dangerous. The accidents may also be due to the large overloaded vehicles traveling on a viaduct, thereby causing the viaduct to be overturned. The accidents may also be due to environmental factors increasing the probability of accidents, thereby endangering the safety of surrounding pedestrians and vehicles. Therefore, the related art may have the problems of poor accuracy of risk analysis and inability to effectively guarantee the safety of the user.

Based on this, embodiments of the present disclosure provide a method, an apparatus, an electronic device, and a storage medium for determining a traffic risk value, which may solve the problems of poor accuracy of risk analysis and inability to effectively guarantee the safety of the user.

The method for determining a traffic risk value provided by some embodiments of the present disclosure is described in detail below with reference to the accompanying drawings.

FIG. 1 is a schematic flowchart of a method for determining a traffic risk value based on some embodiments of the present disclosure. As shown in FIG. 1, the method may include the blocks or operations S110-S130.

At block S110, real-time information of a preset traffic-accident prone area is acquired. The real-time information includes real-time environmental information and real-time vehicle information of vehicles within the traffic-accident prone area.

The preset traffic-accident prone area may be a geographical area where accidents occur frequently. For example, an electronic fence for the traffic-accident prone area may be manually delineated, or an electronic fence for the traffic-accident prone area may be automatically delineated based on the frequency of occurrence of accidents.

The real-time information of the traffic-accident prone area may refer to information of the traffic-accident prone area acquired in real time. The real-time information may include, for example, real-time environmental information and real-time vehicle information of the vehicles within the traffic-accident prone area.

The real-time environmental information may refer to environmental information of the traffic-accident prone area acquired in real time, for example, weather environmental information such as rainy days, foggy days, or nights.

The real-time vehicle information may refer to vehicle information acquired in real time. The vehicle information may be vehicle information that is prone to cause the accidents, such as position information, speed information, vehicle type information, and load information of the vehicles.

In some embodiments, block S110 may be understood that, real-time information of a preset traffic-accident prone area is acquired, the real-time information may include real-time environmental information and real-time vehicle information of vehicles within the traffic-accident prone area.

In some embodiments, before acquiring real-time information of a preset traffic-accident prone area, the method further may include the block or operation as follows.

Delineating an electronic fence to obtain the traffic-accident prone area, based on a number of accidents occurred.

In some embodiments, in a case where the accidents occur frequently, the electronic fence for the area may be manually or automatically generated on a map to obtain the electronic fence for an accident-prone area. That is, the traffic-accident prone area may be delineated by the electronic fence, supporting both manual and automatic generation methods for the electronic fence, thereby achieving higher flexibility and saving manpower.

At block S120, first real-time risk values of a target vehicle as perceived by other vehicles are determined based on the real-time vehicle information. A second real-time risk value of the traffic-accident prone area is determined based on the real-time information.

In some embodiments, block S120 may be understood that, real-time risk values as perceived by the other vehicles to the target vehicle are determined, based on the real-time vehicle information, which may be referred as the first real-time risk value. Based on the real-time information, a real-time risk value of the traffic-accident prone area may also be determined, which may be referred as a second real-time risk value.

In some embodiments, the real-time vehicle information may include position information and speed information. The determining first real-time risk values of a target vehicle as perceived by other vehicles, based on the real-time vehicle information, may include the blocks or operations as follows.

Calculating relative information between the target vehicle and the other vehicles based on the position information and the speed information. The relative information may include relative speeds and relative distances.

Dividing the relative speeds by the relative distances to obtain the first real-time risk values.

The relative information may refer to relative information between two vehicles. For example, in a case where there are N vehicles in the accident-prone area, each vehicle may be called the target vehicle, and the other N−1 vehicles may be called other vehicles. The relative information may be calculated between the target vehicle and the other N−1 vehicles. For example, the relative information may include relative speeds and relative distances.

In some embodiments, the real-time vehicle information may include the position information and the speed information. At block S120, the determining first real-time risk values of other vehicles to the target vehicle, based on the real-time vehicle information, may include: calculating the relative information between the target vehicle and the other vehicles based on the position information and the speed information, the relative information may include the relative speeds and the relative distances; and dividing the relative speeds by the relative distances to obtain the first real-time risk value. For example, a faster relative speeds between the target vehicle and other vehicles may indicate a larger speed difference between the two vehicles, which may be more dangerous and more prone to cause accidents. Therefore, the first real-time risk values may be larger. Meanwhile, a smaller relative distances between the target vehicle and other vehicles may indicate that the distance between the two vehicles is closer, which may be more dangerous and more prone to cause accidents. Therefore, the first real-time risk values may be larger. The degree of real-time risk of other vehicles to the target vehicle may be reflected by the magnitude of the first real-time risk value, thereby effectively guaranteeing the safety of the user.

In some embodiments, the determining, based on the real-time information, a second real-time risk value of the traffic-accident prone area, may include the blocks or operations as follows.

Determining real-time risk contribution values of vehicles within the traffic-accident prone area within the traffic-accident prone area, based on the real-time information.

Summing the real-time risk contribution values of each vehicle to obtain the second real-time risk value of the traffic-accident prone area.

The real-time risk contribution values may refer to a risk value of each vehicle within the traffic-accident prone area acquired in real time.

In some embodiments, at block S120, the determining a second real-time risk value of the traffic-accident prone area, based on the real-time information, may include: determining real-time risk contribution values of vehicles within the traffic-accident prone area within the traffic-accident prone area, based on the real-time information; and summing the real-time risk contribution values of each vehicle to obtain the second real-time risk value of the whole traffic-accident prone area. The degree of real-time risk of the entire traffic-accident prone area may be reflected by the magnitude of the second real-time risk value, thereby effectively guaranteeing the safety of the user.

In some embodiments, the method further may include the blocks or operations as follows.

Determining whether the real-time information satisfies a target trigger condition among a plurality of preset trigger conditions.

Employing a preset high-risk value as the second real-time risk value of the traffic-accident prone area in response to the target trigger condition being satisfied.

The plurality of preset trigger conditions may refer to conditions that are prone to trigger accidents. In a case where one of the plurality of preset trigger conditions is satisfied, an accident may be caused.

The preset high-risk value may refer to a value employed as the second real-time risk value of the traffic-accident prone area in a case where a trigger condition is satisfied. Different trigger conditions may trigger different types of traffic accidents. Therefore, different trigger conditions may correspond to different high-risk values. A larger high-risk value may indicate that the traffic accident triggered is more severe. For example, the high-risk value corresponding to trigger condition 1 may be 100, and the high-risk value corresponding to trigger condition 2 may be 150.

In some embodiments, the method for determining the second real-time risk value of the traffic-accident prone area based on the real-time information at block S120 may further include: determining whether the real-time information satisfies the trigger condition among the plurality of preset trigger conditions, the satisfied trigger condition may be called the target trigger condition; and employing the preset high-risk value as the second real-time risk value of the traffic-accident prone area in response to the target trigger condition being satisfied. That is, the second real-time risk value may be obtained by summing the real-time risk contribution values of all vehicles in the entire area. As speed, vehicle type, and load of each vehicle increase, the second real-time risk value of the entire traffic-accident prone area may become larger. Meanwhile, the magnitude of the second real-time risk value may also be related to trigger conditions. In a case where the real-time information within the traffic-accident prone area satisfies a trigger condition, the second real-time risk value may be assigned to a preset high-risk value, which may also result in the larger second real-time risk value of the entire traffic-accident prone area. Therefore, the degree of real-time risk of the entire traffic-accident prone area may be reflected by the magnitude of the second real-time risk value, improving the accuracy of the risk analysis, thereby effectively guaranteeing the safety of the user.

At block S130, a target real-time risk value based on the first real-time risk values and the second real-time risk value is determined. The target real-time risk value is positively correlated with the first real-time risk values and the second real-time risk value.

In some embodiments, block S130 may be understood that, a target real-time risk value is determined based on the first real-time risk values and the second real-time risk value, the target real-time risk value is positively correlated with the first real-time risk values and the second real-time risk value. For example, the target real-time risk value may be obtained by directly adding the first real-time risk values and the second real-time risk value. The target real-time risk value may also be obtained by the sum of multiplying the first real-time risk values by corresponding weight and multiplying the second real-time risk value by corresponding weight. The target real-time risk value may also be obtained by multiplying the first real-time risk values and the second real-time risk value. Among them, the target real-time risk value may be positively correlated with the first real-time risk value, and the target real-time risk value may be positively correlated with the second real-time risk value simultaneously. That is, the larger the first real-time risk value, the larger the target real-time risk value. The larger the second real-time risk value, the larger the target real-time risk value. The target real-time risk value may reflect the danger degree of the speed and position of the adjacent vehicles to the target vehicle, and may also reflect the danger degree of the entire accident-prone area.

In some embodiments, the real-time vehicle information may include vehicle type information and load information. The determining a target real-time risk value based on the first real-time risk values and the second real-time risk value, may include the blocks or operations as follows.

Summing the second real-time risk value with a vehicle-type risk value to obtain a third real-time risk value. The vehicle-type risk value may be obtained based on the vehicle type information and the load information.

Multiplying the first real-time risk values with the third real-time risk value respectively, to obtain a plurality of fourth real-time risk values.

Summing the plurality of fourth real-time risk values to obtain the target real-time risk value.

The vehicle-type risk value may be obtained based on the vehicle type information and the load information. For example, in a case where the vehicle type is a large truck, the vehicle-type risk value may be higher. In a case where the load is overweight, the vehicle-type risk value may be higher.

In some embodiments, the determining a target real-time risk value based on the first real-time risk values and the second real-time risk value may include: summing the second real-time risk value with a vehicle-type risk value to obtain a result called the third real-time risk value, the vehicle-type risk value may be obtained based on the vehicle type information and the load information; multiplying the first real-time risk values with the third real-time risk value respectively, to obtain a plurality of fourth real-time risk values; and summing the plurality of fourth real-time risk values to obtain the target real-time risk value. The target real-time risk value may reflect the danger degree of the speed, the position, the vehicle type, and the load of surrounding other vehicles to the target vehicle, and may also reflect the danger degree of the entire accident-prone area.

The method for determining a traffic risk value may be provided by some embodiments of the present disclosure. The method may include: acquiring real-time information of a preset traffic-accident prone area. The real-time information includes real-time environmental information and real-time vehicle information of vehicles within the traffic-accident prone area; determining first real-time risk values of a target vehicle as perceived by other vehicles, based on the real-time vehicle information; determining a second real-time risk value of the traffic-accident prone area, based on the real-time information; and determining a target real-time risk value, based on the first real-time risk values and the second real-time risk value, the target real-time risk value is positively correlated with the first real-time risk values and the second real-time risk value. By the real-time vehicle information of vehicles within the traffic-accident prone area, the first real-time risk values of a target vehicle as perceived by other vehicles can be determined. By the real-time vehicle information and real-time environmental information of vehicles within the traffic-accident prone area, the second real-time risk value of the traffic accident-prone area can be determined. In response to the first real-time risk values or the second real-time risk value increase, the target real-time risk value may increase accordingly. Therefore, the driving behavior of adjacent vehicles may be analyzed, whether a certain road section has a safety risk may be determined simultaneously, thereby improving the accuracy of risk analysis and effectively guaranteeing the safety of the user.

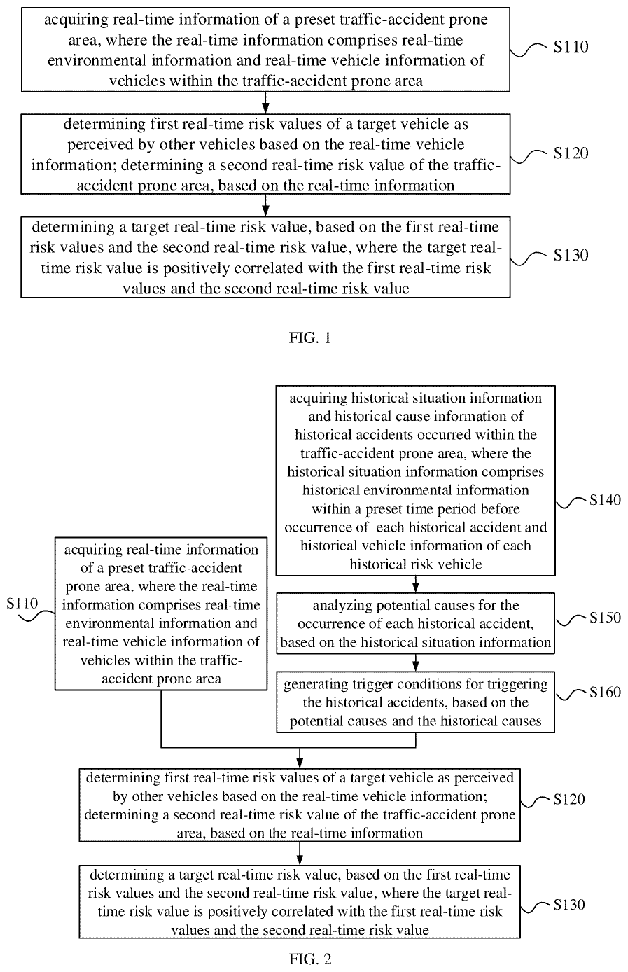

In some embodiments, as shown in FIG. 2, before the determining whether the real-time information satisfies a target trigger condition among a plurality of preset trigger conditions, the method may further include the blocks or operations as follows.

At block S140, historical situation information and historical cause information of historical accidents occurred within the traffic-accident prone area may be acquired. The historical situation information may include historical environmental information within a preset time period before occurrence of each historical accident and historical vehicle information of each historical risk vehicle.

At block S150, potential causes for the occurrence of each historical accident may be analyzed based on the historical situation information.

At block S160, trigger conditions for triggering the historical accidents may be generated based on the potential causes and the historical causes.

The historical situation information may refer to historical environmental information within a preset time period before the occurrence of accident and historical vehicle information of each historical risk vehicle.

The preset time period may refer to a period of time before the occurrence of accident, which may be 10 seconds, 30 seconds, etc. In some embodiments of the present disclosure, the preset time period may be set based on requirements, which is not limited herein.

The historical risk vehicle may refer to a risk vehicle among vehicles within the traffic-accident prone area within the preset time period before the occurrence of accident.

In some embodiments, before the block S120, determining whether the real-time information satisfies a target trigger condition among a plurality of preset trigger conditions, and in response to the target trigger condition being satisfied, employing a preset high-risk value as the second real-time risk value of the traffic-accident prone area, the trigger conditions may be generated by the following blocks or operations S140 to S160.

Block S140 may be understood that, historical situation information and historical cause information of the historical accidents that occurred within the traffic-accident prone area are acquired, the historical situation information may include historical environmental information within a preset time period before the occurrence of accident and historical vehicle information of each historical risk vehicle.

In some embodiments, before the acquiring historical situation information and historical cause information of historical accidents occurred within the traffic-accident prone area, the method further may include the blocks or operations as follows.

Acquiring historical vehicle information of each historical accident occurred within the traffic-accident prone area.

Acquiring a target weight corresponding to the historical vehicle information of each historical accident, based on a preset correspondence relationship between vehicle information and weights.

Determining a risk contribution value of each of historical vehicles based on the target weight.

Determining the risk contribution value greater than a preset contribution threshold as a target risk contribution value.

Employing a historical risk vehicle corresponding to the target risk contribution value as a historical risk vehicle.

In some embodiments, before the acquiring historical situation information and historical cause information of historical accidents occurred within the traffic-accident prone area, the method may further include how to determine a historical risk vehicle: acquiring historical vehicle information of historical accidents occurred within the traffic-accident prone area, such as historical vehicle information of each historical vehicle like position, speed, vehicle type, load, etc.; acquiring the target weight corresponding to the historical vehicle information of each historical accident, based on the preset correspondence relationship between vehicle information and weights; determining a risk contribution value of each of historical risk vehicles, based on the target weight; determining the risk contribution value greater than the preset contribution threshold as the target risk contribution value; and employing the historical risk vehicle corresponding to the target risk contribution value as a historical risk vehicle. Thus, by the historical vehicle information, the historical vehicles that caused the accidents are selected out from multiple historical vehicles. Although the historical risk vehicle may be not direct factors causing the accidents, the selected historical risk vehicle may be indirect causes for the accidents. For example, the historical risk vehicle may be a large truck with blind spots. In a case where the large truck is close to the accident vehicle, the accident vehicle may be forced to collide with a pedestrian in the blind spot. By selecting out the historical risk vehicle, the indirect causes, i.e., potential causes of the accidents may be found at a deeper level. Taking both the potential causes and the direct causes as the fundamental historical causes triggering the accidents, and employing both the potential causes and the direct causes as trigger conditions for impending real-time accidents, a warning reminder message may be sent in time in a case where it is detected that the real-time information satisfies the trigger conditions, thereby reducing the occurrence of real-time accidents.

Block S150 may be understood that the historical environmental information within a preset time period before the occurrences of accidents and historical vehicle information of each historical risk vehicle is analyzed to obtain potential causes for the occurrence of the historical accident. For example, the potential cause may be that the weather within a preset time period before the occurrence of accident is foggy, with visibility less than 50 m. The potential cause may also be rainy weather, with water accumulation depth 2-5 cm, and historical risk factors such as speeding around the accident vehicle.

Block S160 may be understood that fundamental causes of the historical accidents may be generated based on the potential causes and the historical causes. The potential causes and the historical causes are the trigger conditions for the historical accidents. By the historical situation information and historical cause information of historical accidents, trigger conditions for the historical accidents may be analyzed and obtained. By determining whether the real-time information satisfies the trigger conditions, the risk level of the traffic-accident prone area may be determined, i.e., the second real-time risk value of the traffic-accident prone area may be determined, thereby improving the accuracy of the risk analysis, effectively reducing the occurrence of accidents, and guaranteeing the safety of driving.

In some embodiments, the method further may include the blocks or operations as follows.

Sending a warning reminder message to the target vehicle in response to the target real-time risk value is greater than a preset risk threshold.

The preset risk threshold may refer to a risk value that is about to cause an accident. In some embodiments of the present disclosure, the risk threshold may be set based on requirements, which is not limited herein.

In some embodiments, in a case where the target real-time risk value is greater than a preset risk threshold, it may indicate that the risk degree of the surrounding other vehicles and the accident-prone area to the target vehicle is high. The warning reminder message may be sent to the target vehicle, thereby guaranteeing the safety of the target vehicle and effectively reducing the occurrences of the accidents.

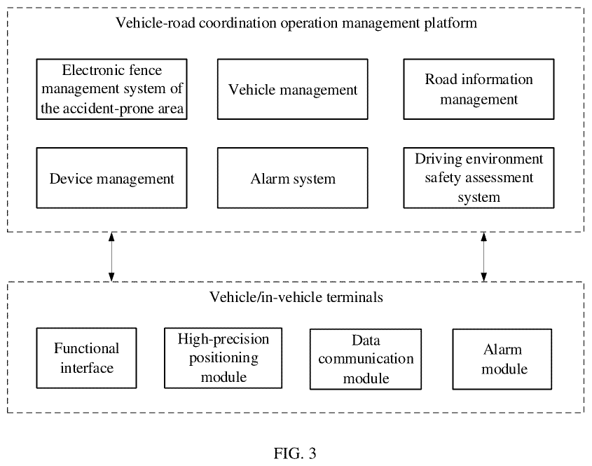

In exemplary techniques, as shown in FIG. 3, a system for determining a traffic risk value may be, for example, a driving environment safety dynamic assessment method and warning system based on V2X. The system may include: V2X vehicle/in-vehicle terminals and a V2X vehicle-road coordination operation management platform. Among them, the in-vehicle terminals may be equipped with a V2X-SDK functional interface, a high-precision positioning module, a data communication module, and an alarm module. The V2X vehicle-road coordination operation management platform may provide information analysis and management services such as an electronic fence management system of the traffic-accident prone area, vehicle management, road information management, device management, an alarm system, and a driving environment safety assessment system. The V2X vehicle/in-vehicle terminals may communicate with the V2X vehicle-road coordination operation management platform via a cellular network.

The operations for determining a traffic risk value by the system are as follows.
1) Delineation of an electronic fence of the traffic-accident prone area and scene restoration, i.e., after delineating a traffic-accident prone area, restore occurrence scenes of the historical accident within the area to obtain the historical causes directly causing the historical accident.

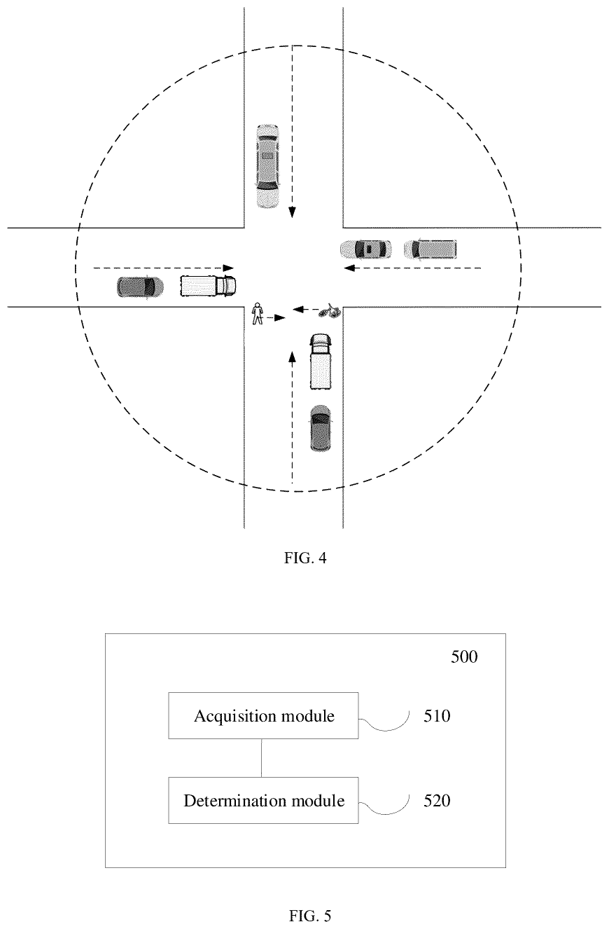

In some embodiments, as shown in FIG. 4, a V2X platform administrator may set the electronic fence of the traffic-accident prone area through the V2X vehicle-road coordination operation management platform, such as the circular dashed area in FIG. 4. The electronic fence of the traffic-accident prone area of any range may be manually delineated, and the time of the occurrence of accident, impact factor Ri of the historical accident, and occurrence condition Ci corresponding to the impact factor Ri may be input.

The impact factor Ri may be vehicle attributes or driving behaviors, such as vehicle type, speeding, overload; the impact factor Ri may also be environmental factors such as rainy days, foggy days, nights, etc.

The occurrence condition Ci may indicate that in a case where the impact factor Ri reach the occurrence condition Ci, the historical accident may occur. For example, in a case where a historical accident occurred in a certain traffic-accident prone area, and the impact factor Ri of a vehicle may be 120 km/h, the corresponding occurrence condition Ci may be speed exceeding 100 km/h. The impact factor Ri reaching the Ci condition may cause the historical accident.
2) Analyzing potential causes indirectly causing the historical accident based on historical situation information within a preset time period before the occurrence of accident.

In some embodiments, the V2X vehicle-road coordination operation management platform, based on the input occurrence time of the historical accident, may collect vehicle type, speed, heading angle, driving lane, and other information of all vehicles within the current electronic fence of the traffic-accident prone area region 10 seconds before the occurrence time of the historical accident. The driving behavior of the vehicles within the traffic-accident prone area before the historical accident, the impact factor Ri, and the occurrence condition Ci corresponding to the impact factor Ri of the occurrence of accident may be analyzed.
3) Take the potential causes indirectly causing the historical accident together with the historical causes directly causing the historical accident as the fundamental causes of the accident, i.e., the trigger conditions for the historical accident.

For example, the direct cause of a historical accident may be that a car collided with a pedestrian at a crossroad. The potential causes may be analyzed based on the situation 10 seconds before the occurrence of accident. There may be a large truck driving in front of the car 10 seconds before the accident. Due to the obstruction of the large truck, the car could not recognize the traffic light status at the crossroad. As a result, after the large truck left the current lane in a case where the traffic signal light is about to turn red (i.e., it was currently green), the car following the large truck may also intend to leave the current lane. In this case, the traffic light may just change from green to red. Due to the obstruction of the large truck, the car could not recognize the traffic light status at the crossroad in time, causing the car to collide with the pedestrian. Therefore, the potential causes in the above example may be: at a crossroad, the vehicle type of the vehicle in front of the target vehicle is a large truck; the traffic signal light is about to change from green to red; and there are pedestrians and bicycles waiting to cross the road.

For another example, the direct cause of a historical accident may be that two cars collided, with the rear vehicle rear-ending the front vehicle. Based on the historical information at the time of the accident, the environmental information at the time of the accident may be foggy weather with visibility 50 m, road surface humidity may be damp, and the following distance between the two vehicles before the accident may be 5 m. Therefore, the potential causes are: foggy weather, with visibility ≤50 m, or road surface humidity that is damp or overly wet, with following distance ≤5 m.
4) Acquiring real-time information within the traffic-accident prone area in real time, determine whether the trigger conditions are satisfied, and determine the real-time risk value of each vehicle.

V2X in-vehicle devices may send the vehicle's high-precision position information and vehicle information to the V2X Server platform at a fixed frequency. In a case where a vehicle vₖ drives into the fence area and triggers the condition Ci corresponding to the accident factor Ri set for the current traffic-accident prone area, a dangerous coefficient pᵥ_{ₖ} of the vehicle vₖ affecting a driving environment of the current traffic-accident prone area may increase.
5) Determining the second real-time risk value R_{d} of the traffic-accident prone area. For example, the second real-time risk value R_{d} may be the current safety coefficient of the driving environment in the traffic-accident prone area estimated in real time, and calculated as

$${R}_{d} = {\sum }_{i = 1}^{i = N} {p}_{{v}_{k}} .$$

6) Determining the first real-time risk values of a target vehicle as perceived by other vehicles. For example, the relative speeds between the target vehicle and other vehicles are set to be _{Δ}v, the relative distances between the target vehicle and other vehicles are set to be Δs, so that the first real-time risk values may be Δv/Δs.
7) Determine the target real-time risk value based on the first real-time risk values of a target vehicle as perceived by other vehicles and the second real-time risk value of the entire traffic-accident prone area. In a case where the target real-time risk value is greater than a risk threshold, a warning reminder message may be sent to the target vehicle.

In some embodiments, based on vehicle data driving on the current road section such as vehicle type, vehicle speed, vehicle spacing, road status, and vehicle driving lane, the current vehicle driving environment safety coefficient may be estimated in real time, i.e., the target real-time risk value RTi.

$${RT}_{i} = {\sum }_{i = 1}^{i = N} \frac{Δ {v}_{i}}{Δ {s}_{i}} ( {p}_{i} + {R}_{d} )$$

Among them, i may refer to the i-th other vehicle. _{Δ}vᵢ/_{Δ}sᵢ may refer to the first real-time risk values of a target vehicle as perceived by other vehicles. A larger relative driving speed and a closer relative distance may refer to a greater risk to the target vehicle. pi may refer to the risk influence coefficient of the vehicle type and the load of the other vehicles on the driving environment, e.g., the risk influence coefficient pi may be larger for large vehicles such as heavy-duty freight trucks, oil tankers, etc. Rd may refer to the risk value of the traffic-accident prone area. The higher the risk level of the traffic-accident prone area, the larger the Rd value. In a case where the current area/road section is not an traffic-accident prone area, Rd may be 0.

RTᵢ_{_{ΔT}} may refer to the relative change value of the real-time risk of the target vehicle within the _{Δ}T time period. In a case where the real-time information satisfies the trigger conditions, and the RTᵢ_{_{ΔT}} of the target vehicle increases rapidly, or the real-time risk value RTi of the target vehicle exceeds a preset risk threshold D, a warning reminder message may be issued to vehicles in the traffic-accident prone area to reduce the possibility of the accidents. Differentiated and effective reminders may also be issued based on the impact factors Ri of different vehicles, achieving the purpose of reducing the safety risk of the current driving environment. The impact factors Ri may be vehicle attributes or driving behaviors, such as vehicle type, speeding, overload. The impact factors Ri may also be environmental factors such as rainy days, foggy days, nights, etc.

FIG. 5 is a schematic diagram of an apparatus for determining a traffic risk value based on some embodiments of the present disclosure. The apparatus 500 may include an acquisition module 510 and a determination module 520.

The acquisition module 510 may be configured to acquire real-time information of a preset traffic-accident prone area. The real-time information includes real-time environmental information and real-time vehicle information of vehicles within the traffic-accident prone area.

The determination module 520 may be configured to determine first real-time risk values of a target vehicle as perceived by other vehicles, based on the real-time vehicle information. The determination module may further be configured to determine a second real-time risk value of the traffic-accident prone area, based on the real-time information.

The determination module 520 may further be configured to determine a target real-time risk value, based on the first real-time risk values and the second real-time risk value. The target real-time risk value may be positively correlated with the first real-time risk values and the second real-time risk value.

The apparatus for determining a traffic risk value may be provided by some embodiments of the present disclosure. The apparatus may be configured to: acquiring real-time information of a preset traffic-accident prone area. The real-time information includes real-time environmental information and real-time vehicle information of vehicles within the traffic-accident prone area; determining first real-time risk values of a target vehicle as perceived by other vehicles, based on the real-time vehicle information; determining a second real-time risk value of the traffic-accident prone area, based on the real-time information; and determining a target real-time risk value, based on the first real-time risk values and the second real-time risk value, the target real-time risk value is positively correlated with the first real-time risk values and the second real-time risk value. By the real-time vehicle information of vehicles within the traffic-accident prone area, the first real-time risk values of a target vehicle as perceived by other vehicles can be determined. By the real-time vehicle information and real-time environmental information of vehicles within the traffic-accident prone area, the second real-time risk value of the traffic accident-prone area can be determined. In response to the first real-time risk values or the second real-time risk value increase, the target real-time risk value may increase accordingly. Therefore, the driving behavior of adjacent vehicles may be analyzed, whether a certain road section has a safety risk may be determined simultaneously, thereby improving the accuracy of risk analysis and effectively guaranteeing the safety of the user.

In some embodiments, the real-time vehicle information may include position information and speed information. The determination module may be configured to determine first real-time risk values of a target vehicle as perceived by other vehicles, based on the real-time vehicle information of the vehicles. The determination module may include the units as follows.

A calculation unit, configured to calculate relative information between the target vehicle and the other vehicles, based on the position information and the speed information. The relative information may include relative speeds and relative distances

The calculation unit may further be configured to divide the relative speeds by the relative distances respectively to obtain the first real-time risk values.

In some embodiments, the determination module may further be configured to determine a second real-time risk value of the traffic-accident prone area, based on the real-time information. The determination module may include the units as follow.

A determination unit, configured to determine real-time risk contribution values of vehicles within the traffic-accident prone area, based on the real-time information.

A calculation unit, configured to sum the real-time risk contribution values of vehicles within the traffic-accident prone area, to obtain the second real-time risk value of the traffic-accident prone area.

In some embodiments, the apparatus further may include the modules as follows.

A judgment module, configured to determine whether the real-time information satisfies a target trigger condition among a plurality of preset trigger conditions.

The judgment module may further be configured to employ a preset high-risk value as the second real-time risk value of the traffic-accident prone area in response to the target trigger condition being satisfied.

In some embodiments, the real-time vehicle information may include vehicle type information and load information. The determination module may further be configured to determine a target real-time risk value, based on the first real-time risk values and the second real-time risk value. The determination module may further include the units as follow.

The calculation unit may further be configured to multiply the first real-time risk values with the third real-time risk value respectively, to obtain a plurality of fourth real-time risk values.

The calculation unit may further be configured to sum the plurality of fourth real-time risk values, to obtain the target real-time risk value.

In some embodiments, before determining whether the real-time information satisfies a target trigger condition among a plurality of preset trigger conditions, the apparatus further may include an analysis module and a generation module.

The acquisition module may be configured to acquire historical situation information and historical cause information of historical accidents occurred within the traffic-accident prone area, the historical situation information may include historical environmental information within a preset time period before an occurrence of accident and historical vehicle information of each historical risk vehicle.

The analysis module may be configured to analyze potential causes for the occurrence of accident, based on the historical situation information.

The generation module may be configured to analyze trigger conditions for triggering the historical accident based on the potential causes and the historical causes.

In some embodiments, before the acquisition module is configured to acquire historical situation information and historical cause information of the historical accident occurred within the traffic-accident prone area, the apparatus may further include the modules as follows.

The acquisition module may be configured to acquire historical vehicle information of historical accidents that occurred within the traffic-accident prone area.

The acquisition module may further be configured to acquire a target weight corresponding to the historical vehicle information of each historical accident, based on a preset correspondence relationship between vehicle information and weights.

The determination module may be configured to determine a risk contribution value of each of historical vehicles, based on the target weight.

The determination module may further be configured to determine the risk contribution value greater than a preset contribution threshold as a target risk contribution value.

The determination module may further be configured to employ a historical vehicle corresponding to the target risk contribution value as a historical risk vehicle.

In some embodiments, the apparatus further may include the modules as follows.

A sending module, configured to send a warning reminder message to the target vehicle in response to the target real-time risk value being greater than a preset risk threshold.

In some embodiments, before the acquisition module is configured to acquire real-time information of a preset traffic-accident prone area, the apparatus further may include the modules as follows.

A delineation module, configured to delineate an electronic fence to obtain the traffic-accident prone area based on a number of accidents occurred.

The various modules in the apparatus for determining a traffic risk value provided by some embodiments of the present disclosure may execute the functions of the blocks or operations of the method for determining a traffic risk value provided in FIGS. 1-4 and achieve the corresponding technical effects. For the sake of brevity, they will not be repeated here.

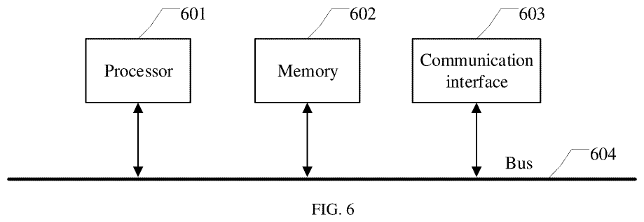

FIG. 6 is a schematic structural diagram of an electronic device for determining a traffic risk value provided by some embodiments of the present disclosure.

The electronic device for determining a traffic risk value may include a processor 601 and a memory 602 storing computer program instructions.

In some embodiments, the processor 601 may include a Central Processing Unit (CPU), or an Application Specific Integrated Circuit (ASIC), or one or more integrated circuits configured to execute one or more embodiments of the present disclosure.

The memory 602 may include a mass storage for data or instructions. For example, but not limited to, the memory 602 may include a Hard Disk Drive (HDD), a floppy disk drive, flash memory, an optical disc, a magneto-optical disc, magnetic tape, or a Universal Serial Bus (USB) drive, or a combination of two or more of these. In some embodiments, the memory 602 may include removable or non-removable (or fixed) media. In some embodiments, the memory 602 may be internal or external to the electronic device for determining a traffic risk value. In some embodiments, the memory 602 may be non-volatile solid-state memory.

The memory may include Read Only Memory (ROM), Random Access Memory (RAM), magnetic disk storage media devices, optical storage media devices, flash memory devices, electrical, optical, or other physical/tangible memory storage devices. Therefore, in general, the memory may include one or more tangible (non-transitory) computer-readable storage media (e.g., memory devices) encoded with software including computer-executable instructions, and when the software is executed (e.g., by one or more processors), the memory may perform the operations described with reference to the method based on the first aspect of the present disclosure.

The processor 601, by reading and executing the computer program instructions stored in the memory 602, may execute any of the methods for determining a traffic risk value described in the above embodiments.

In exemplary techniques, the electronic device for determining a traffic risk value may further include a communication interface 603 and a bus 604. As shown in FIG. 6, the processor 601, the memory 602, and the communication interface 603 are connected and communicate with each other via the bus 604.

The communication interface 603 may be mainly used to execute communication between the modules, the apparatuses, the units, and/or the devices in some embodiments of the present disclosure.

The bus 604 may include hardware, software, or both, coupling the components of the electronic device for determining a traffic risk value to each other. By way of example and not limitation, the bus may include an Accelerated Graphics Port (AGP) or other graphics bus, an Extended Industry Standard Architecture (EISA) bus, a Front Side Bus (FSB), a Hyper Transport (HT) interconnect, an Industry Standard Architecture (ISA) bus, an InfiniBand interconnect, a Low Pin Count (LPC) bus, a memory bus, a MicroChannel Architecture (MCA) bus, a Peripheral Component Interconnect (PCI) bus, a PCI-Express (PCI-X) bus, a Serial Advanced Technology Attachment (SATA) bus, a Video Electronics Standards Association Local Bus (VLB), or other suitable bus, or a combination of two or more of these. In some embodiments, the bus 604 may include one or more buses. Although specific buses are described and illustrated in some embodiments of the present disclosure, the present disclosure contemplates any suitable bus or interconnect.

The electronic device may execute the method for determining a traffic risk value in some embodiments of the present disclosure based on each unit/component in the apparatus for determining a traffic risk value, thereby implementing the method for determining a traffic risk value described with reference to FIG. 1 to FIG. 4.

In addition, in combination with the above-described method for determining a traffic risk value, some embodiments of the present disclosure may be executed by providing a computer storage medium. The computer storage medium may store computer program instructions thereon. In a case where the computer program instructions executed by a processor, execute any of the methods for determining a traffic risk value described in the above embodiments.

The present disclosure may also provide a computer program product. In a case where the instructions of the computer program product are executed by a processor of an electronic device, the electronic device may perform the blocks or operations of any of the method embodiments for determining a traffic risk value described above.

It should be made clear that the present disclosure is not limited to the specific configurations and processes described above and illustrated in the drawings. For the sake of brevity, detailed descriptions of known methods are omitted herein. In the above embodiments, several blocks or operations are described and illustrated as examples. However, the method process of the present disclosure is not limited to the specific steps described and illustrated. Those skilled in the art may make various changes, modifications, and additions, or change the order between steps after understanding the spirit of the present disclosure.

The functional blocks shown in the structural block diagrams above may be executed as hardware, software, firmware, or a combination thereof. In a case where the blocks or operations are executed in a hardware form, it may be, for example, an electronic circuit, an Application Specific Integrated Circuit (ASIC), appropriate firmware, a plug-in, a function card, etc. In a case where the blocks or operations are executed in a software form, the elements of the present disclosure are programs or code segments used to perform the required tasks. The programs or code segments may be stored in a machine-readable medium or transmitted via a data signal carried in a carrier wave over a transmission medium or communication link. The machine-readable medium may include any medium capable of storing or transmitting information. Examples of machine-readable media include electronic circuits, semiconductor memory devices, Read-Only Memory (ROM), flash memory, Erasable Read Only Memory (EROM), floppy disks, Compact Disc Read-Only Memory (CD-ROM), optical discs, hard disks, fiber optic media, Radio Frequency (RF) links, etc. Code segments may be downloaded via a computer network such as the Internet, an intranet, etc.

It should also be noted that the exemplary embodiments mentioned in the present disclosure describe some methods or systems based on a series of operations or apparatuses. However, the present disclosure is not limited to the order of the above operations. That is, the operations may be performed in the order mentioned in some embodiments, or in an order different from that in some embodiments, or several operations may be performed simultaneously.

Aspects of the present disclosure are described above with reference to flowchart illustrations and/or block diagrams of methods, apparatuses (systems), and computer program products based on embodiments of the present disclosure. It should be understood that each block in the flowchart and/or block diagram, and combinations of blocks in the flowchart and/or block diagram, can be executed by computer program instructions. The computer program instructions may be provided to a processor of a general-purpose computer, a special-purpose computer, or other programmable data processing apparatus to produce a machine, such that the instructions, when executed via the processor of the computer or other programmable data processing apparatus, enable execution of the functions/acts specified in one or more blocks of the flowchart and/or block diagram. The processor may be, but is not limited to, a general-purpose processor, a special-purpose processor, a special application processor, or a field-programmable logic circuit. It is also understood that each block in the block diagrams and/or flowchart illustration, and combinations of blocks in the block diagrams and/or flowchart illustration, may also be executed by dedicated hardware that performs the specified functions or acts, or by a combination of dedicated hardware and computer instructions.

The foregoing is merely specific embodiments of the present disclosure. Those skilled in the art can clearly understand that, for the convenience and brevity of description, the specific working processes of the systems, modules, and units described above may refer to the corresponding processes in the foregoing method embodiments and are not repeated here. It should be understood that the protection scope of the present disclosure is not limited thereto. Any person skilled in the art can easily think of various equivalent modifications or substitutions within the technical scope disclosed in the present disclosure. These modifications or substitutions should be covered within the protection scope of the present disclosure.

1. A method for determining a traffic risk value, comprising:
acquiring real-time information of a preset traffic-accident prone area, wherein the real-time information comprises real-time environmental information and real-time vehicle information of vehicles within the traffic-accident prone area;
determining first real-time risk values of a target vehicle as perceived by other vehicles based on the real-time vehicle information; determining a second real-time risk value of the traffic-accident prone area, based on the real-time information; and
determining a target real-time risk value, based on the first real-time risk values and the second real-time risk value, wherein the target real-time risk value is positively correlated with the first real-time risk values and the second real-time risk value.

2. The method as claimed in claim 1, wherein the real-time vehicle information comprises position information and speed information; and the determining first real-time risk values of a target vehicle as perceived by other vehicles, based on the real-time vehicle information, comprises:
calculating relative information between the target vehicle and the other vehicles based on the position information and the speed information, wherein the relative information comprises relative speeds and relative distances; and
dividing the relative speeds by the relative distances respectively, to obtain the first real-time risk values.

3. The method as claimed in claim 1, wherein the determining a second real-time risk value of the traffic-accident prone area, based on the real-time information, comprises:
determining real-time risk contribution values of vehicles within the traffic-accident prone area, based on the real-time information; and
summing the real-time risk contribution values of vehicles within the traffic-accident prone area, to obtain the second real-time risk value of the traffic-accident prone area.

4. The method as claimed in claim 3, further comprising:
determining whether the real-time information satisfies a target trigger condition among a plurality of preset trigger conditions; and
employing a preset high-risk value as the second real-time risk value of the traffic-accident prone area in response to the target trigger condition being satisfied.

5. The method as claimed in claim 1, wherein the real-time vehicle information comprises vehicle type information and load information; the determining a target real-time risk value, based on the first real-time risk values and the second real-time risk value, comprises:
summing the second real-time risk value with a vehicle-type risk value to obtain a third real-time risk value, wherein the vehicle-type risk value is obtained, based on the vehicle type information and the load information;
multiplying the first real-time risk values with the third real-time risk value respectively, to obtain a plurality of fourth real-time risk values; and
summing the plurality of fourth real-time risk values, to obtain the target real-time risk value.

6. The method as claimed in claim 4, wherein before the determining whether the real-time information satisfies a target trigger condition among a plurality of preset trigger conditions, the method further comprises:
acquiring historical situation information and historical cause information of historical accidents occurred within the traffic-accident prone area, wherein the historical situation information comprises historical environmental information within a preset time period before occurrence of each accident and historical vehicle information of each historical risk vehicle;
analyzing potential causes for the occurrence of each historical accident, based on the historical situation information; and
generating trigger conditions for triggering the historical accidents, based on the potential causes and the historical causes.

7. The method as claimed in claim 6, wherein before the acquiring historical situation information and historical cause information of historical accidents occurred within the traffic-accident prone area, the method further comprises:
acquiring historical vehicle information of each historical accident occurred within the traffic-accident prone area;
acquiring a target weight corresponding to the historical vehicle information of each historical accident, based on a preset correspondence relationship between vehicle information and weights;
determining a risk contribution value of each of historical vehicles, based on the target weight;
determining the risk contribution value greater than a preset contribution threshold as a target risk contribution value; and
employing a historical vehicle corresponding to the target risk contribution value as a historical risk vehicle.

8. The method as claimed in claim 1, further comprising:
sending a warning reminder message to the target vehicle, in response to the target real-time risk value being greater than a preset risk threshold.

9. The method as claimed in claim 1, wherein before the acquiring real-time information of a preset traffic-accident prone area, the method further comprises:
delineating an electronic fence to obtain the traffic-accident prone area, based on a number of accidents occurred.

10. An electronic device, comprising:
a processor; and
a memory, storing computer program instructions;
wherein in a case where the computer program instructions are executed, the processor executes a method for determining a traffic risk value, the method comprises:
acquiring real-time information of a preset traffic-accident prone area, wherein the real-time information comprises real-time environmental information and real-time vehicle information of vehicles within the traffic-accident prone area;
determining first real-time risk values of a target vehicle as perceived by other vehicles based on the real-time vehicle information; determining a second real-time risk value of the traffic-accident prone area, based on the real-time information; and
determining a target real-time risk value, based on the first real-time risk values and the second real-time risk value, wherein the target real-time risk value is positively correlated with the first real-time risk values and the second real-time risk value.

11. The electronic device as claimed in claim 10, wherein the real-time vehicle information comprises position information and speed information; and the determining first real-time risk values of a target vehicle as perceived by other vehicles, based on the real-time vehicle information, comprises:
calculating relative information between the target vehicle and the other vehicles based on the position information and the speed information, wherein the relative information comprises relative speeds and relative distances; and
dividing the relative speeds by the relative distances respectively, to obtain the first real-time risk values.

12. The electronic device as claimed in claim 10, wherein the determining a second real-time risk value of the traffic-accident prone area, based on the real-time information, comprises:
determining real-time risk contribution values of vehicles within the traffic-accident prone area, based on the real-time information; and
summing the real-time risk contribution values of vehicles within the traffic-accident prone area, to obtain the second real-time risk value of the traffic-accident prone area.

13. The electronic device as claimed in claim 12, wherein the method executed by the electronic device further comprises:
determining whether the real-time information satisfies a target trigger condition among a plurality of preset trigger conditions; and
employing a preset high-risk value as the second real-time risk value of the traffic-accident prone area in response to the target trigger condition being satisfied.

14. The electronic device as claimed in claim 10, wherein the real-time vehicle information comprises vehicle type information and load information; the determining a target real-time risk value, based on the first real-time risk values and the second real-time risk value, comprises:
summing the second real-time risk value with a vehicle-type risk value to obtain a third real-time risk value, wherein the vehicle-type risk value is obtained, based on the vehicle type information and the load information;
multiplying the first real-time risk values with the third real-time risk value respectively, to obtain a plurality of fourth real-time risk values; and
summing the plurality of fourth real-time risk values, to obtain the target real-time risk value.

15. The electronic device as claimed in claim 13, wherein before the determining whether the real-time information satisfies a target trigger condition among a plurality of preset trigger conditions, the method further comprises:
acquiring historical situation information and historical cause information of historical accidents occurred within the traffic-accident prone area, wherein the historical situation information comprises historical environmental information within a preset time period before occurrence of each accident and historical vehicle information of each historical risk vehicle;
analyzing potential causes for the occurrence of each historical accident, based on the historical situation information; and
generating trigger conditions for triggering the historical accidents, based on the potential causes and the historical causes.

16. The electronic device as claimed in claim 15, wherein before the acquiring historical situation information and historical cause information of historical accidents occurred within the traffic-accident prone area, the method further comprises:
acquiring historical vehicle information of each historical accident occurred within the traffic-accident prone area;
acquiring a target weight corresponding to the historical vehicle information of each historical accident, based on a preset correspondence relationship between vehicle information and weights;
determining a risk contribution value of each of historical vehicles, based on the target weight;
determining the risk contribution value greater than a preset contribution threshold as a target risk contribution value; and
employing a historical vehicle corresponding to the target risk contribution value as a historical risk vehicle.

17. The electronic device as claimed in claim 10, wherein the method executed by the electronic device further comprises:
sending a warning reminder message to the target vehicle, in response to the target real-time risk value being greater than a preset risk threshold.

18. The electronic device as claimed in claim 10, wherein before the acquiring real-time information of a preset traffic-accident prone area, the method further comprises:
delineating an electronic fence to obtain the traffic-accident prone area, based on a number of accidents occurred.

19. A non-transitory computer-readable storage medium, wherein computer-readable program instructions are stored on the computer-readable storage medium, and in a case where the computer-readable program instructions are executed by a processor, the computer-readable program instructions are configured to execute a method for determining a traffic risk value, the method comprises:
acquiring real-time information of a preset traffic-accident prone area, wherein the real-time information comprises real-time environmental information and real-time vehicle information of vehicles within the traffic-accident prone area;
determining first real-time risk values of a target vehicle as perceived by other vehicles based on the real-time vehicle information; determining a second real-time risk value of the traffic-accident prone area, based on the real-time information; and
determining a target real-time risk value, based on the first real-time risk values and the second real-time risk value, wherein the target real-time risk value is positively correlated with the first real-time risk values and the second real-time risk value.
